(19) United States
(12) Patent Application Publication
(10) Pub. No.: US 2024/0333673 A1
(43) Pub. Date: Oct. 3, 2024

(54) INFORMATION PROCESSING METHOD AND DEVICE THEREOF

(71) Applicant: Lenovo (Beijing) Limited, Beijing (CN)

(72) Inventors: Chenguang YANG, Beijing (CN); Meng WANG, Beijing (CN)

(21) Appl. No.: 18/607,021

(22) Filed: Mar. 15, 2024

(30) Foreign Application Priority Data
Mar. 29, 2023 (CN) 202310322992.9

(51) Int. Cl. H04L 51/216; H04L 51/04

(52) U.S. Cl. CPC H04L 51/216; H04L 51/04

(57) ABSTRACT

An information processing method includes determining at least two sessions corresponding to a first session object and having one-to-one correspondence with at least two second session objects, analyzing the at least two sessions, to obtain session stages of the at least two sessions currently in corresponding session processes, determining that at least one session satisfies a preset condition based on the session stages of the at least two sessions currently in the corresponding session processes, and allocating at least one second session object to be connected to the first session object.

### CROSS-REFERENCE TO RELATED APPLICATION

This application claims priority to Chinese Patent Application No. 202310322992.9, filed on Mar. 29, 2023, the entire content of which is incorporated herein by reference.

### TECHNICAL FIELD

The present disclosure generally relates to the field of information technologies and, more particularly, to an information processing method and device thereof.

### BACKGROUND

For text channels, such as user services accessed from WeChat, official websites or apps (Applications), an online agent needs to serve multiple user consultations at the same time.

The busyness level of an online agent often be measured only based on the quantity of users that the online agent serves at the same time. For example, when one online agent, e.g., one engineer, serves 5 users at the same time and another engineer serves 4 users at the same time, the former is considered busier than the latter. During peak periods, such as summer sales or e-commerce festivals, every engineer is fully occupied, and the quantity of calls all reach the upper limit. At this time, which engineer, a user queuing behind should be assigned to for maximizing service carrying capacity and reducing overall user queue time, will have a crucial impact on the service experience.

### SUMMARY

In accordance with the present disclosure, there is provided an information processing method including: including: determining at least two sessions corresponding to a first session object and having one-to-one correspondence with at least two second session objects, analyzing the at least two sessions, to obtain session stages of the at least two sessions currently in corresponding session processes, determining that at least one session satisfies a preset condition based on the session stages of the at least two sessions currently in the corresponding session processes, and allocating at least one second session object to be connected to the first session object.

In accordance with the present disclosure, there is also provided an electronic device including at least one processor and at least one memory. The at least one memory is configured to store executable program instructions that, when being executed, cause at least one processor to: determine at least two sessions corresponding to a first session object, where the at least two sessions have one-to-one correspondence with at least two second session objects; analyze the at least two sessions, to obtain session stages of the at least two sessions currently in corresponding session processes; and determine that at least one session satisfies a preset condition based on the session stages of the at least two sessions currently in the corresponding session processes, and allocate at least one second session object to be connected to the first session object.

In accordance with the present disclosure, there is also provided a non-transitory computer-readable storage medium, configured to store executable program instructions that, when being executed, cause at least one processor to: determine at least two sessions corresponding to a first session object, where the at least two sessions have one-to-one correspondence with at least two second session objects; analyze the at least two sessions, to obtain session stages of the at least two sessions currently in corresponding session processes; and determine that at least one session satisfies a preset condition based on the session stages of the at least two sessions currently in the corresponding session processes, and allocate at least one second session object to be connected to the first session object.

### BRIEF DESCRIPTION OF THE DRAWINGS

FIG. 1 is a flow chart of an information processing method consistent with various embodiments of the present disclosure.

FIG. 2 is a flow chart of another information processing method consistent with various embodiments of the present disclosure.

FIG. 3 is a flow chart of another information processing method consistent with various embodiments of the present disclosure.

FIG. 4 is a flow chart of another information processing method consistent with various embodiments of the present disclosure.

FIG. 5 is schematic diagram of a first model of the information processing method in FIG. 4, consistent with various embodiments of the present disclosure.

FIG. 6 is a flow chart of another information processing method consistent with various embodiments of the present disclosure.

FIG. 7 is a flow chart of another information processing method consistent with various embodiments of the present disclosure.

FIG. 8 is a schematic diagram of a second model of the information processing method in FIG. 6, consistent with various embodiments of the present disclosure.

FIG. 9 is a flow chart of another information processing method consistent with various embodiments of the present disclosure.

FIG. 10 is a flow chart of another information processing method consistent with various embodiments of the present disclosure.

FIG. 11 is a flow chart of another information processing method consistent with various embodiments of the present disclosure.

FIG. 12 is a structural schematic diagram of an information processing device consistent with various embodiments of the present disclosure.

### DETAILED DESCRIPTION OF THE EMBODIMENTS

Specific embodiments of the present disclosure are hereinafter described with reference to the accompanying drawings. The described embodiments are merely examples of the present disclosure and should not be regarded as limitations of this application. All other embodiments obtained by those of ordinary skill in the art without creative efforts fall within the scope of protection of the present disclosure.

In the present disclosure, reference is made to “some embodiments” which describe a subset of all possible embodiments, but it is understood that “some embodiments” may be the same subset or a different subset of all possible embodiments, and can be combined with each other without conflict.

The terms “first/second/third” involved are only used to distinguish similar objects and do not represent a specific ordering of objects. It is understood that “first/second/third” can be used interchangeably if permitted. The specific order or sequence may be changed such that the embodiments of the present disclosure described herein can be implemented in an order other than that illustrated or described herein.

Unless otherwise defined, all technical and scientific terms used herein have the same meaning as commonly understood by those of ordinary skill in the art in the technical field to which the present disclosure belongs. The terminology used herein is for the purpose of describing the present disclosure only and does not intend to limit the scope of the present disclosure. The nouns and terms involved in the embodiments of the present disclosure will be first described. The nouns and terms involved in the embodiments of the present disclosure are applicable to the following explanations.

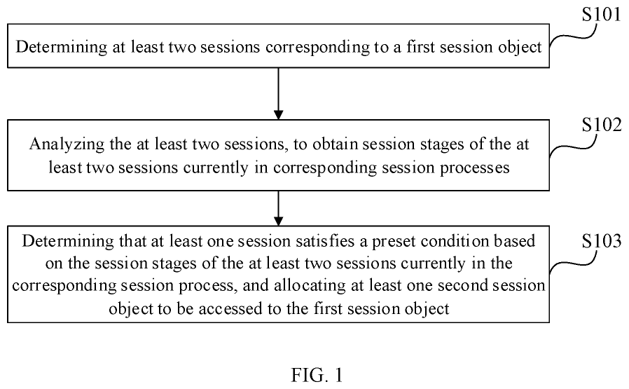

The present disclosure provides an information processing method. In one embodiment shown in FIG. 1, which is a flow chart of the information processing method applied to an electronic device, the method includes S101 to S103.

In S101: at least two sessions corresponding to a first session object are determined.

The at least two sessions may correspond to at least two second session objects on a one-to-one basis.

The electronic device to whom the information processing method provided by the present disclosure is applied to may be a server of a certain application, and the server may be able to connect multiple engineer terminals and client terminals.

Engineers on the engineer terminals may provide consulting services to customers on the client terminals.

The first session object may be an engineer who provides services, and one second session object may be a customer who needs services.

One session may be a session between the first session object and one second session object, and the interactive session between the first session object and the second session object may be recorded.

For example, in one embodiment, the first session object may be an engineer who provides services, and one second session object may be a customer who needs service. The customer may consult on one or several issues, and the engineer may provide feedback on the issues. The content generated by this process may be the session covered in the present embodiment.

In one embodiment, multiple sessions corresponding to the first session object may be determined based on an identity of the first session object, and each session may be formed by the first session object and one corresponding second session object.

In one embodiment, during an online peak period, the quantity of sessions corresponding to the first session object may be an upper limit of the second session objects that the first session object is able to serve.

For example, the upper limit that one engineer is able to serve may be 5, and the quantity of sessions that the first session object is able to correspond to may be no more than 5. In the present embodiment, the quantity of the corresponding sessions may be 5, which is the upper limit.

In S102, the at least two sessions are analyzed to obtain the session stages currently in corresponding session processes respectively.

One session may be divided into multiple stages based on progress.

Each of the multiple sessions of the first session object may be respectively analyzed to obtain the current session stage of each session in one corresponding session process.

In one embodiment, for example, the session stages may include: a greeting stage, a problem locating stage, a problem solving stage, or a finishing stage.

The above embodiment with these stages is used as an example only to illustrate the present disclosure, and does not limit the scope of the present disclosure. In various embodiments, the session may be divided into other stage types according to actual conditions.

The analysis process will be explained in detail in subsequent embodiments, and will not be described in detail here.

In S103, based on the session stages of the at least two sessions currently in the corresponding session processes, at least one session is determined to satisfy a preset condition, and at least one second session object to be connected is allocated to the first session object.

In one embodiment, based on the fact that the session stage of at least one session among the multiple sessions corresponding to the first session object satisfies the preset condition, one second session object to be connected may be allocated to the first session object.

That the at least one session corresponding to the first session object satisfies the preset condition, may mean that the at least one session is about to end, or the quantity of sessions that the first session object is responsible does not reach the maximum quantity that the first session object is able to handle.

In one embodiment, when one or more sessions corresponding to the first session object are about to end and sessions corresponding to other first session objects just start or in the process, the one or more sessions corresponding to the first session object may end earlier. Therefore, the second session object in the queue may be preferentially allocated to the first session object, such that the session with the second session object to be connected is immediately started after a certain session of the first session object ends, to reduce the waiting time of the second session object.

In one embodiment, when one or more sessions corresponding to the first session object are about to end, the first session object may not need to invest too much energy in the one or more sessions that are about to end, and may be capable of freeing up additional services for other second session objects. Therefore, the second session objects queued later may be preferentially allocated to the first session object, such that the service efficiency of the first session object may be improved while reducing the waiting time of the second session object.

In the information processing method provided by the present embodiment, for the session stages in which the multiple sessions corresponding to the first session object are currently located in the corresponding session processes, when the session stages in which one or more sessions are located satisfies the preset condition, the second session object to be connected may be allocated to the first session object. After one session corresponding to the first session object ends, the session with the second session object to be connected may be started immediately, to reduce the waiting time of the second session object.

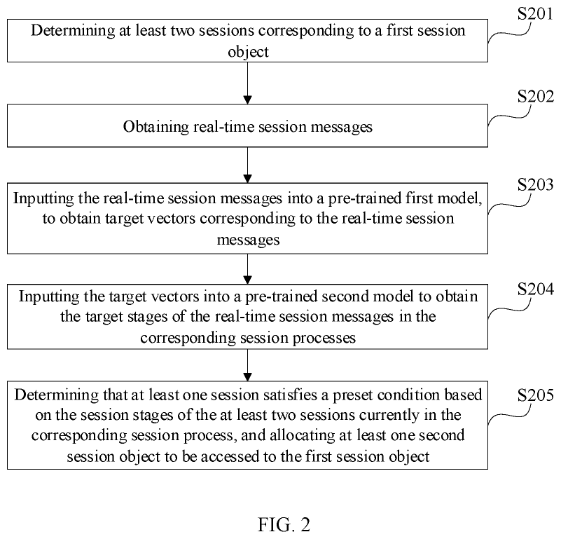

Another embodiment of the present disclosure shown in FIG. 2 provides another information processing method. As shown in FIG. 2, which is a flow chart of the information processing method, the method includes S201 to S205.

In S201: at least two sessions corresponding to a first session object are determined.

S201 is similar to S101 in the previous embodiment and will not be described in detail here.

In S202, real-time session messages are obtained.

The real-time session messages may be generated by the first session object or the at least one second session object.

For each session, the real-time session messages generated by the first session object and the corresponding second session object in the session may be obtained.

After the first session object or the second session object generates the session messages, the real-time session messages may be obtained in real time.

The obtained real-time session messages may carry identity information of objects that generated the real-time session messages.

The real-time session messages may include long sentences, short sentences, etc.

In S203, the real-time session messages may be input into a pre-trained first model to obtain target vectors (embedding) corresponding to the real-time session messages.

The first model may be a sentence-level model, and may be able to obtain the sentence-level target vectors by processing the input sentences.

In one embodiment, the first model may use a sentence-level bidirectional encoder representations from the transformer (BERT) model.

After obtaining one real-time session message, the real-time session message may be input into the pre-trained first model. The real-time session message may be a sentence, and then the first model may output a sentence-level vector. The sentence-level vector may be one target vector in the current step.

The first model may be trained in advance based on training sample sentences. This training process will be described in subsequent embodiments, and will not be described in detail in this embodiment.

In S204, the target vectors are input into a pre-trained second model to obtain the target stages of the real-time session messages in the corresponding session processes.

The second model may be a trained model, and may be used to label the stages of the real-time session messages in the corresponding session processes.

The input of the second model may be vectors, and the output may be the session stages corresponding to the vectors.

In one embodiment, the second model may use a BiLSTM (bi-long short term memory network)+CRF (conditional random field) sequence labeling model.

The second model may be trained in advance based on training samples. The training process will be described in subsequent embodiments, and will not be described in detail in this embodiment.

In S205, based on the session stages of the at least two sessions currently in the corresponding session processes, at least one session is determined to satisfy the preset condition, and at least one second session object to be connected is allocated to the first session object.

S205 is consistent with the corresponding steps in previous embodiments, and will not be described again in this embodiment.

In the information processing method provided by this embodiment, the real-time session messages generated by the first session object and/or the second session object may be obtained. Based on the pre-trained first model and the pre-trained second model, the real-time session messages may be sequentially input into the first model to obtain the sentence-level target vectors corresponding to the real-time session messages, and the target vectors may be input into the second model, and the target stage of the real-time session messages currently in the corresponding session processes may be obtained. Correspondingly, the session stages of the multiple sessions corresponding to the first session object may be analyzed to obtain the stages of the multiple sessions corresponding to the first session object, which provides a basis for subsequent allocation of second session objects to be connected.

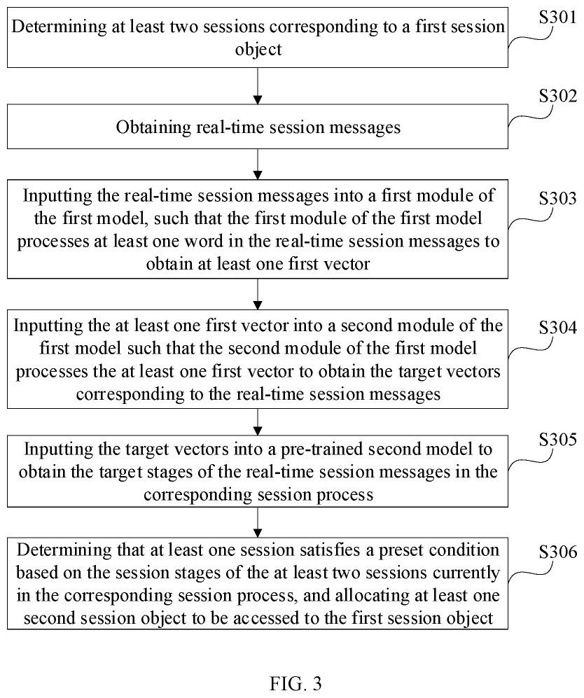

Another embodiment of the present disclosure shown in FIG. 3 provides another information processing method. As shown in FIG. 3 which is a flow chart of the information processing method, the method includes S301 to S206.

In S301: at least two sessions corresponding to a first session object are determined.

In S302, real-time session messages are obtained.

S301 and S302 are similar to corresponding steps in the previous embodiment and will not be described in detail here.

In S303, the real-time session messages are input into a first module of the first model, such that the first module of the first model processes at least one word in the real-time session messages to obtain at least one first vector.

The at least one first vector may correspond to words in the real-time session messages.

The first model may include the first module and a second module.

In one embodiment, the first module of the first model may be configured to process each word in the real-time session messages to obtain a corresponding first vector, and the first vector may be a word vector.

The quantity of the words in the real-time session messages may be the same as the quantity of the first vectors.

In one embodiment, the first module of the first model may adopt the BERT model.

The real-time session messages may be input into the first module of the first model to obtain multiple word vectors.

In S304, the at least one first vector is input into a second module of the first model, such that the second module of the first model processes the at least one first vector to obtain target vectors corresponding to the real-time session messages.

The second module of the first model may be configured to process a set of input vectors to obtain target vectors of preset dimensions.

In one embodiment, the second module of the first model may perform feature extraction on a set of word vectors input by the first module to obtain the sentence-level target vectors corresponding to the real-time session messages.

In one embodiment, the second module of the first model may be provided with a pooling layer for feature extraction.

In one embodiment, a pooling strategy adopted by the pooling layer may include taking the average of all word vectors (MEAN-strategy).

In one embodiment, the word vectors corresponding to the same real-time session messages may be averaged to obtain the characteristics of the real-time session messages.

In S305, the target vectors are input into a pre-trained second model to obtain the target stages of the real-time session messages in the corresponding session processes.

In S306, based on the session stages of the at least two sessions currently in the corresponding session processes, at least one session is determined to satisfy the preset condition, and at least one second session object to be connected is allocated to the first session object.

S305 and S306 are consistent with the corresponding steps in previous embodiments, and will not be described again in this embodiment.

In the information processing method provided by the present embodiment, by inputting the real-time session messages into the first module of the first model, the plurality of first vectors at the word level may be obtained. Then, the plurality of first vectors may be input into the second module of the first model to obtain the sentence-level target vectors, achieving the process of obtaining the target vectors corresponding to the real-time session messages.

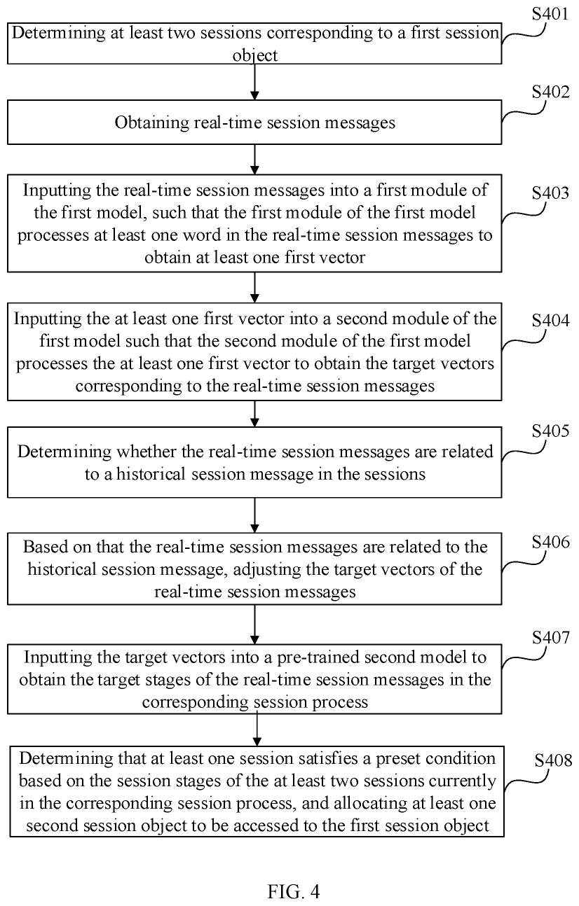

Another embodiment of the present disclosure shown in FIG. 4 provides another information processing method. As shown in FIG. 4 which is a flow chart of the information processing method, the method includes S401 to S408.

In S401: at least two sessions corresponding to a first session object are determined.

In S402, real-time session messages are obtained.

In S403, the real-time session messages are input into a first module of the first model, such that the first module of the first model processes at least one word in the real-time session messages to obtain at least one first vector.

In S404, the at least one first vector is input into the second module of the first model, such that the second module of the first model processes the at least one first vector to obtain target vectors corresponding to the real-time session messages.

S401 to S404 are similar to corresponding steps in the previous embodiment and will not be described in detail here.

In S405, whether one real-time session message is related to the historical session message in the session is determined.

The present embodiment includes a process of fine-tuning the target vectors output by the first model.

Whether the real-time session message is related to the historical session message in the same session may be determined.

Generally, the historical session message may include a session message adjacent or close to the real-time session message.

In one embodiment, an absolute difference between the target vector corresponding to the real-time session message and a vector corresponding to the historical session message may be used to determine whether the real-time session message is related to the historical session message. When the absolute difference between the target vector and the vector corresponding to the historical session message is smaller, the correlation between the real-time session message and the historical session message may be larger.

By identifying whether the real-time session message is related to the historical session message, the purpose of analyzing based on the context may be achieved.

When the real-time session message is related to the historical session message, S406 may be performed. When the real-time session message is not related to the historical session message, S407 may be performed directly.

In S406, based on the correlation between the real-time session message and the historical session message, the target vector of the real-time session message is adjusted.

In one embodiment, when the real-time session message is related to the historical session message, the target vector of the real-time session message may be adjusted, such that the target vector is closer to the vector corresponding to the historical session message to improve the accuracy of subsequent determination of the stage of the real-time session message based on the target vector.

In one embodiment, a softmax classifier may be used to adjust the target vector of real-time session message.

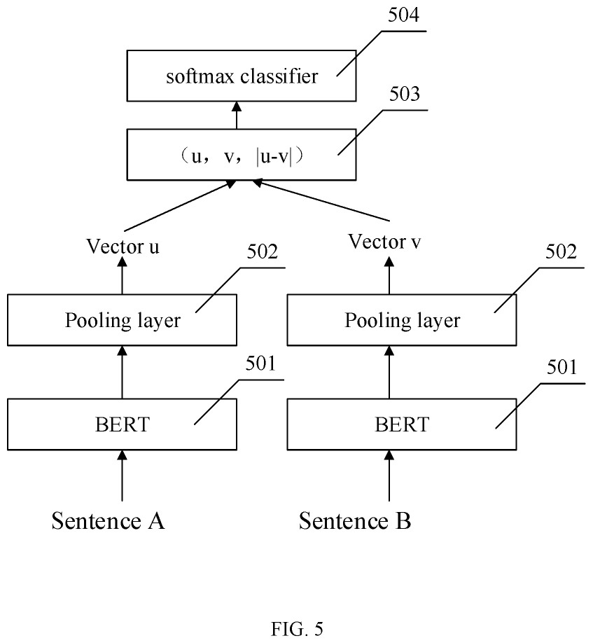

As shown in FIG. 5 which is a structural schematic diagram of the first model, in one embodiment, the first model includes: a first module 501, a second module 502, a correlation judgment module 503, and a vector adjustment module 504. The first module uses BERT and the second module 502 uses the pooling layer. The correlation judgment module 503 is configured to determine the correlation between two sentences, and the absolute difference between the vectors of the two sentences may be used for determination. The vector adjustment module 504 is configured to use the softmax classifier. Sentence A and sentence B are input into the first model. Sentence A is a historical session message, and sentence B is a real-time session message. Sentence A and sentence B are processed by the first module and the second module respectively to obtain the vector u of sentence A and the vector v of sentence B. The correlation is judged based on vector u and vector v using (u, v, |u−v|). The judgment result is input to the vector adjustment module. The softmax classifier adjusts the vector of sentence B based on the judgment result.

In S407, the target vectors are input into a pre-trained second model to obtain the target stages of the real-time session messages currently in the corresponding session processes.

In S408, based on the current session stages of the at least two sessions in the corresponding session process, at least one session is determined to satisfy the preset condition, and at least one second session object to be connected is allocated to the first session object.

S407 and S408 are consistent with the corresponding steps in previous embodiments, and will not be described again in this embodiment.

In the information processing method provided by the present embodiment, whether the real-time session message is related to the historical session message in the session may be determined based on the target vector corresponding to the real-time session message and the vector corresponding to the historical session message. When the real-time session message is related to one historical session message, the target vector of the real-time session message may be adjusted, such that the target vector is closer to the vector corresponding to the historical session message. By combining the context of the session to adjust the target vector corresponding to the real-time session message, the accuracy of subsequent determination of the stage of the real-time session message may be improved.

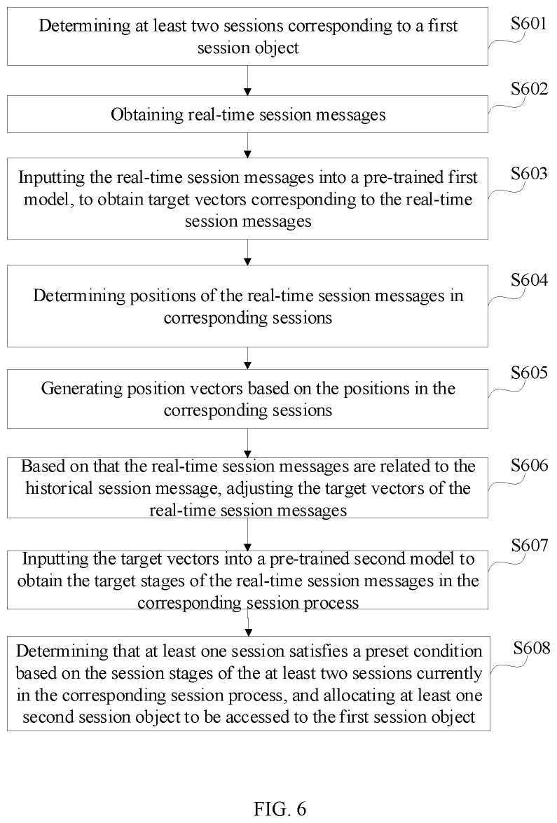

Another embodiment of the present disclosure shown in FIG. 6 provides another information processing method. As shown in FIG. 6 which is a flow chart of the information processing method, the method includes S601 to S607.

In S601: at least two sessions corresponding to a first session object are determined.

In S602, real-time session messages are obtained.

In S603, the real-time session messages are input into a first module of the first model, to obtain the target vectors corresponding to the real-time session messages.

S601 to S603 are similar to corresponding steps in the previous embodiment and will not be described in detail here.

In S604, a position of one real-time session message in the session to which the real-time session message belongs is determined.

In one embodiment, the position of the real-time session message in the session to which the real-time session message belongs may be determined.

In one embodiment, the position may be specifically represented by the order of the real-time session message in the session.

For example, in a certain session, 15 session sentences have been generated, and then one real-time session message is obtained. The position of the real-time session message in the session is determined to be the 16th sentence.

Of course, in other embodiments, the position of the real-time session message in the session may also be represented in other forms, which is not specifically limited in the present disclosure.

In S605, a position vector is generated based on the position in the session.

In S606, the position vector and the target vector are input to the second model, to obtain a target stage of the real-time session message in the corresponding session process.

Processing may be performed based on the position within the corresponding session process to generate the position vector.

The position vector and the target vector corresponding to the real-time session message may be input into the second model.

When the second model processes and determines the stage of the real-time session message currently in the corresponding session process, the position of the real-time session message in the session may be combined, to improve the accuracy of the stage of the real-time session message.

In S607, based on the current session stages of the at least two sessions in the corresponding session processes, at least one session is determined to satisfy the preset condition, and at least one second session object to be connected is allocated to the first session object.

S607 is consistent with the corresponding steps in previous embodiments, and will not be described again in this embodiment.

In the information processing method provided by the present embodiment, the position vector may be generated based on the position of the real-time session message in the corresponding session. The position vector and the target vector may be input to the second model, to obtain the target stage of the real-time session message in the corresponding session process. By processing the real-time session message in conjunction with the position of the real-time session message in the session, the position of the real-time session message in the session may be combined to improve the accuracy of the stage of the real-time session message.

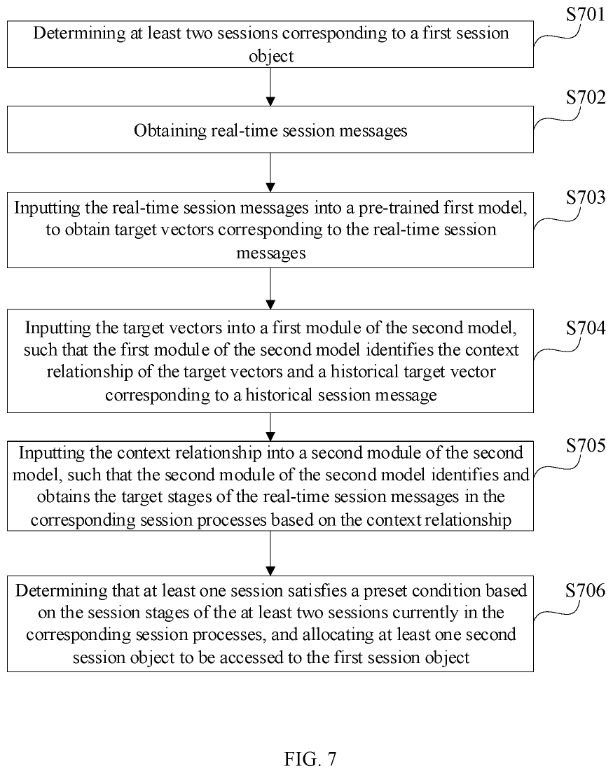

Another embodiment of the present disclosure shown in FIG. 7 provides another information processing method. As shown in FIG. 7 which is a flow chart of the information processing method, the method includes S701 to S706.

In S701: at least two sessions corresponding to a first session object are determined.

In S702, real-time session message are obtained.

In S703, the real-time session messages are input into a first module of the first model, to obtain the target vectors corresponding to the real-time session messages.

S701 to S703 are similar to corresponding steps in the previous embodiment and will not be described in detail here.

In S704, the target vectors are input into the first module of the second model, such that the first module of the second model identifies the contextual relationship between the target vectors and the historical target vector corresponding to the historical session message.

The second model may include the first module and the second module.

In one embodiment, the first module of the second model may be configured to determine the contextual relationship between the real-time session messages and the historical session message based on the historical target vector corresponding to the historical session message and the target vectors.

In one embodiment, the first module of the second model may adopt the BiLSTM module.

The first module of the second model may process multiple continuous or non-continuous session messages respectively to obtain the contextual relationship between the session messages.

In S705, the context relationship is input into the second module of the second model, such that the second module of the second model identifies and obtains the target stages of the real-time session messages currently in the corresponding session processes based on the context relationship.

The second module of the second model may be configured to identify the stages of the real-time session messages in the corresponding session processes in conjunction with the context relationship.

In one embodiment, the contextual relationship between each session message and one real-time session message may be input into the second module of the second model. The second module of the second model may combine the contextual relationship to obtain the probability of one real-time session message at each stage in one corresponding session processes, and determine one stage with the largest probability value as the target stage.

In one embodiment, the second module of the second model may use CRF.

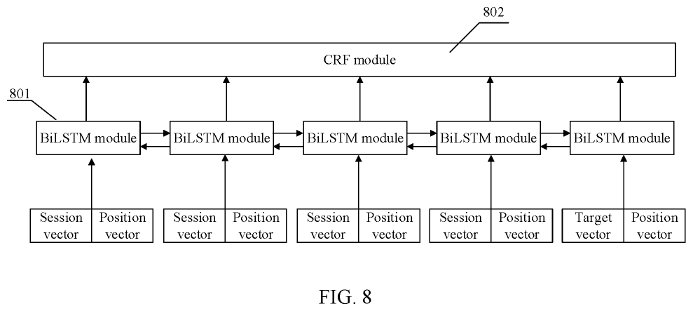

FIG. 8 is a schematic diagram showing a second model. The second model may include a plurality of BiLSTM modules 801 and a plurality of CRF modules 802. In the embodiment shown in FIG. 8, the second model includes five BiLSTM modules 801 and five CRF modules 802. The session vector of one session message in one session and the position vector corresponding to the session message may form a set of inputs. A plurality of session messages contained in one session may form a plurality of sets of inputs. Each set of inputs may be input into one corresponding BiLSTM module 801, and the BiLSTM module may process and obtain the relationship between the context of each set of input features, and its output may include the transmission probability matrix of one corresponding CRF module. The CRF matrix may calculate the state transition probability based on the output results of each BiLSTM module, to obtain the probability of the real-time session message at each stage in the session process and determine one stage with the largest probability value as the stage of the session message. In the embodiment shown in FIG. 8, the second model processes 5 sets of inputs at a time, including 4 session vectors of historical session messages and the corresponding position vectors input sequentially, 1 target vector of the real-time session messages and the corresponding position vector. The output of each BiLSTM module may include the relationship between the real-time session message and the previous four session messages. The CRF may output the stage to which the real-time session message belongs.

In S707, based on the current session stages of the at least two sessions in the corresponding session processes, at least one session is determined to satisfy the preset condition, and at least one second session object to be connected is allocated to the first session object.

S707 is consistent with the corresponding steps in previous embodiments, and will not be described again in this embodiment.

In the information processing method provided by the present embodiment, the target vectors may be input into the first module of the second model, such that the first module of the second model identifies the contextual relationship between the target vectors and the historical target vector corresponding to the historical session message. The context relationship may be input to the second module of the second model, such that the second module of the second model identifies and obtains the target stages of the real-time session messages in the corresponding session processes based on the context relationship. The real-time session messages may be combined with the historical session message to obtain the context relationship of the real-time session messages, and the stages to which the real-time session messages belong may be identified based on the context relationship of the real-time session messages. Therefore, the accuracy of identifying the stages of the real-time session messages in the corresponding session processes may be improved.

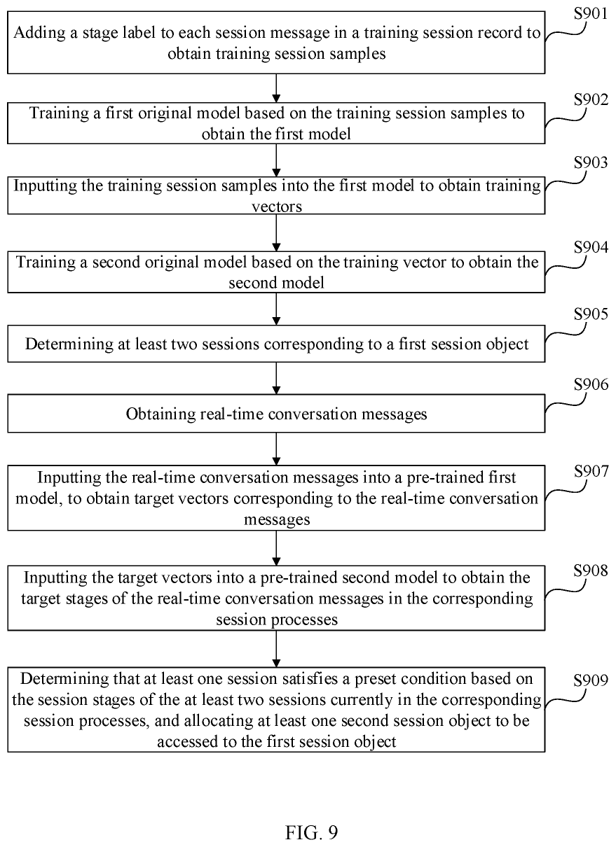

Another embodiment of the present disclosure shown in FIG. 9 provides another information processing method. As shown in FIG. 9 which is a flow chart of the information processing method, the method includes S901 to S909.

In S901, a stage label is added to each session message in a training session record to obtain training session samples.

The training session record may be prepared in advance, and the training session record may include a plurality of session messages. The plurality of session messages may belong to different session stages.

Stage labels may be added to the session messages of different session stages to obtain the training session samples.

In one embodiment, the training session record may be a historical session between an engineer and a customer, and a session stage label may be added to each session message in the historical session.

In S902: a first original model is trained based on the training session samples to obtain the first model.

The training session samples may be input into the first original model to train the first original model and obtain the first model.

In one embodiment, the first original model may be trained based on the training session samples to obtain the first trained model.

The first model that has been trained may process the input session messages in the form of sentences to obtain sentence-level vectors.

In S903, the training session samples are input into the first model to obtain training vectors.

The training session samples may be input into the first model that has been trained, and the first model may output the training vectors.

The training vectors may be sentence-level vectors.

In S904, a second original model is trained based on the training vectors to obtain the second model.

The second original model may be trained based on the training vectors to obtain the trained second model.

The trained second model may be able to identify the input vectors and obtain the session stage to which its corresponding session message belongs.

In S905, at least two sessions corresponding to a first session object are determined.

In S906, real-time session messages are obtained.

In 907, the real-time session messages are input into a pre-trained first model to obtain target vectors corresponding to the real-time session messages.

In S908, the target vectors are input into a pre-trained second model to obtain the target stages of the real-time session messages in the corresponding session processes.

In S909, based on the current session stages of the at least two sessions in the corresponding session processes, at least one session is determined to satisfy the preset condition, and at least one second session object to be connected is allocated to the first session object.

S905 to S909 are consistent with the corresponding steps in previous embodiments, and will not be described again in this embodiment.

In the present embodiment, the information processing method may further include training the first model and the second model. Training the first model and the second model may include: adding a stage label to each session message in a training session record to obtain training session samples, training the first original model based on the training session samples to obtain the first model, inputting the training session samples into the first model to obtain training vectors, and training the second original model based on the training vectors to obtain the second model. The training processes of the first model and the second model may be provided in advance, to provide basis for subsequently determining the stage of the real-time session message in the session process.

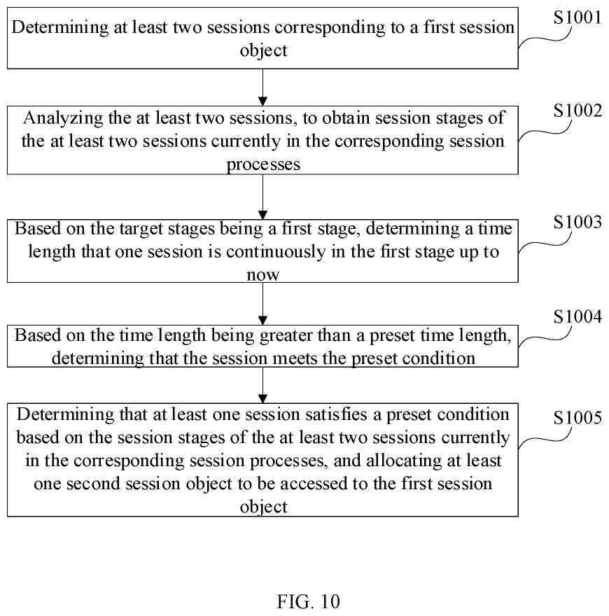

Another embodiment of the present disclosure shown in FIG. 10 provides another information processing method. As shown in FIG. 10 which is a flow chart of the information processing method, the method includes S1001 to S1005.

In S1001, at least two sessions corresponding to a first session object are determined.

In S1002, real-time session messages are obtained.

S1001 to S1002 are consistent with the corresponding steps in previous embodiments, and will not be described again in this embodiment.

In S1003, in response to one target stage which is a first stage, a time length that one corresponding session has been continuously in a first stage until the current moment is determined.

The first stage may be a stage that is about to end, such as a closing stage.

In one embodiment, when it is determined that a certain session is in the first stage, the time length that the session has been in the first stage until the current moment may be determined.

In one embodiment, the time of the most recent and consecutive session message in the first stage may be used as the start timing of the first stage.

In one embodiment, after the stage of a certain session is determined, the stage of the previous session message may be adjusted based on the currently determined real-time session message.

For example, when the stage of the previous session message is adjusted, and the adjusted stage of the session message is also the first stage, the timing may start from the time of the previous session message.

For example, when it is determined that the session to which it belongs is in the first stage based only on the current session message, the current session message may be used as the starting time.

In S1004, in response to the time length that is larger than a preset time length, the session is determined to satisfy the preset condition.

The preset time length may be the normal end time length of a session, and the preset time length may be set according to actual conditions.

In one embodiment, the time length may be set longer, such as 120 seconds, 100 seconds, etc.

When the second session object has new questions and continues to raise them within the preset time, the session may be switched to other stages (such as the problem locating stage). When there are no new questions within the preset time, it may be indicated that the second session object has no new problems and the first session object may not need to spend more energy to deal with the second session object, such that the session may be ended.

When the preset time length is reached, the time length that the session message of the second session object is not received may be counted. When the session message of the second session object is not received within the preset time length, the session may be automatically terminated to improve the efficiency of the session of this first session object.

In S1005, based on the current session stages of the at least two sessions in the corresponding session process, at least one session is determined to satisfy the preset condition, and at least one second session object to be connected is allocated to the first session object.

S1005 is consistent with the corresponding steps in previous embodiments, and will not be described again in this embodiment.

In the present embodiment, the information processing method may include: in response to the target stage which is the first stage, the time length that the corresponding session is continuously in the first stage until now may be determined. In response to the time length which is larger than the preset time length, it may be determined that the session satisfies the preset condition. In this embodiment, in response to the time length of a certain session in the first stage which is larger than the preset time length, it may be determined that the session meets the preset conditions and the session may be about to end. Therefore, one second session object to be connected may be allocated to the first session object, to improve the working efficiency of the first session object and reduce the waiting time of the second session object.

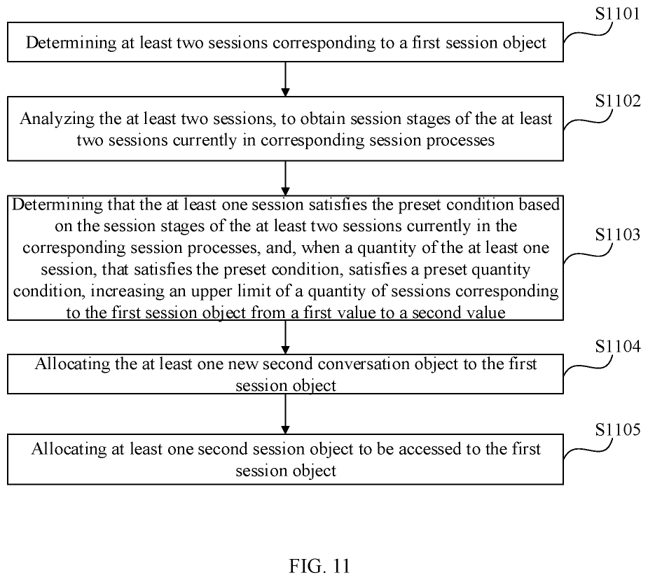

Another embodiment of the present disclosure shown in FIG. 11 provides another information processing method. As shown in FIG. 11, which is a flow chart of the information processing method, the method includes S1101 to S1105.

In S1101, at least two sessions corresponding to a first session object are determined.

In S1102, real-time session messages are obtained.

S1101 to S1102 are consistent with the corresponding steps in previous embodiments, and will not be described again in this embodiment.

In S1103, based on the session stages of the at least two sessions currently in the corresponding session processes, it is determined that at least one session satisfies the preset condition. When the quantity of sessions that satisfy the preset condition meets a preset quantity condition, the upper limit quantity of sessions corresponding to the first session object is increased from a first value to a second value.

The quantity of the at least two second session objects may be equal to the first value.

In one embodiment, at least one of the at least two sessions corresponding to the first session object may satisfy the preset condition, and the quantity of sessions that satisfy the preset condition may satisfy the preset quantity condition.

In one embodiment, the preset quantity condition may be that the quantity of sessions that satisfy the preset condition is half or more of the total quantity of sessions, etc.

Correspondingly, the quantity of sessions corresponding to the first session object may be increased, and more second session objects may be directly allocated to the first session object.

In S1104, at least one new second session object is allocated to the first session object.

The sum of the quantity of the at least two second session objects and the quantity of the newly allocated at least one second session object may be equal to the second value.

The at least one new second session object may be directly allocated to the first session object, such that the quantity of second session objects corresponding to the first session object reaches the increased second value, thereby improving the work efficiency of the first session object and further reducing the waiting time of the second session object.

It should be noted that after adjusting the upper limit quantity of sessions corresponding to the first session object, one new second session object may be directly allocated to the first session object, such that the first session object allocates part of its energy to the new second session object, thereby improving the work efficiency of the first session object and further reducing the waiting time of the second session object.

For example, the first session object corresponds to 5 sessions, 3 of which meet the preset conditions. Therefore, only 2 of the sessions that the first session object is responsible for may occupy the first session object's energy, and 3 sessions may be about to end. Correspondingly, the first session object may soon have enough remaining energy to be responsible for more second session objects. Therefore, the quantity of sessions corresponding to the first session object may be increased to 6, and a new second session object may be added to the first session object.

In S1105, one second session object to be connected is allocated to the first session object.

In one embodiment, one second session object to be connected may be allocated to the first session object, and the second session object to be connected may wait for the finish of the sessions of the first session object in processing to establish a session with the first session object.

In the information processing method provided by the present embodiment, based on the session stages of the at least two sessions in the session process, it may be determined that at least one session satisfies the preset condition. When the quantity of sessions that satisfy the preset condition meets a preset quantity condition, the upper limit quantity of sessions corresponding to the first session object may be increased from a first value to a second value. The quantity of the at least two second session objects may be equal to the first value. At least one new second session object is allocated to the first session object. The sum of the quantity of the at least two second session objects and the quantity of the newly allocated at least one second session object may be equal to the second value. One second session object to be connected is allocated to the first session object. When the quantity of sessions that meet the preset condition satisfies the preset quantity condition, it may be indicated that the first session object has enough remaining energy. Therefore, the upper limit quantity of sessions corresponding to the first session object may be increased, and new second session objects may be directly allocated to the first session object, to improve the work efficiency of the first session object and reduce the waiting time of the second session object.

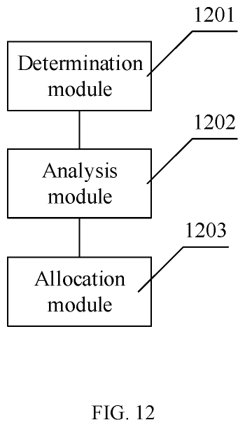

The present disclosure also provides an information processing device. As shown in FIG. 12, in one embodiment, the information processing device may include a determination module 1201, an analysis module 1202, and an allocation module 1203.

The determination module 1201 may be configured to determine at least two sessions corresponding to the first session object. The at least two sessions may correspond to at least two second session objects one-to-one.

The analysis module 1202 may be configured to analyze the at least two sessions, to obtain the session stages of the at least two sessions currently in the corresponding session processes.

The allocation module 1203 may be configured to determine at least one session from the at least two sessions that satisfies a preset condition based on the session stages of the at least two sessions currently in the corresponding session processes, and allocate at least one second session object to be connected to the first session object.

In one embodiment, the analysis module may include: an acquisition unit, configured to obtain real-time session messages, where the real-time session messages are generated by the first session object or the second session objects; a first model unit, configured to input the real-time session messages into a pre-trained first model, to obtain the target vectors corresponding to the real-time session messages; and a second model unit, configured to input the target vectors into the pre-trained second model to obtain the target stages of the real-time session messages in the session process.

In one embodiment, the first model unit may be configured to: input one real-time session message into the first module of the first model, such that a first module of the first model processes at least one word in the real-time session message to obtain at least one first vector corresponding to the at least one word in the real-time session message; and input the at least one first vector into a second module of the first model such that the second module of the first model processes the at least one first vector to obtain a target vector corresponding to the real-time session message.

Optionally, in one embodiment, the first model unit may be further configured to determine whether the real-time session message is related to the historical session message in the session after processing the at least one first vector based on the preset processing rules to obtain the target vector corresponding to the real-time session message; and, based on the correlation between the real-time session message and the historical session message, adjust the target vector of the real-time session message.

In one embodiment, the second model unit may be configured to: determine the position of the real-time session message in the session; generate a position vector based on the position in the session; and input the position vector and the target vector into the second model, to obtain the target stage of the real-time session message in the session.

In one embodiment, the second model unit may be configured to: input the target vector into a first module of the second model, such that the first module of the second model identifies the context relationship of the target vector and a historical target vector corresponding to the historical session message; and, input the context relationship into a second module of the second model, such that the second module of the second model identifies and obtains the target stage of the real-time session message in the session based on the context relationship.

In one embodiment, the device may further include a training module, configured to train the first model and the second model.

The training module may be configured to: add a stage label to each session message in a training session record to obtain training session samples; train a first original model based on the training session samples to obtain the first model; input the training session samples into the first model to obtain training vectors; train a second original model based on the training vector to obtain the second model.

In one embodiment, the device may further include a judgment module, configured to determine the time length that the session is in a first stage based on the target stage being the first stage; and based on time length being larger than a preset time length, determine that the session meets a preset condition.

Optionally, in one embodiment, the allocation module may include:
a determining unit, configured to determine that at least one session satisfies the preset condition based on the session stage of the at least two sessions during the session, and, when the quantity of the at least one session satisfying the preset condition satisfies a preset quantity condition, increase the upper limit quantity of sessions corresponding to the first session object from a first value to a second value, where the quantity of the at least two second session objects equals to the first value;
a first allocation unit, configured to allocate at least one new second session object to the first session object, where the sum of the quantity of the at least two second session objects and the quantity of the newly allocated at least one second session object equals to the second value; and
a second allocation unit, configured to allocate at least one second session object to be connected to the first session object.

For the details of each unit in the information processing device, references may be made to the previous embodiments about the information processing method.

In the information processing device provided by the present disclosure, for the session stage in which the multiple sessions corresponding to the first session object are currently in the session process, when the session stage of one or more of the multiple sessions are located satisfies the preset condition, the at least one second session object to be connected may be allocated to the first session object. Therefore, when one session corresponding to the first session object is finished, the first session object may immediately start a session with the second session object to be connected, to reduce the waiting time of the second session object.

The present disclosure also provides an electronic device and a readable storage medium corresponding to the information processing method.

The electronic device may include a memory and a processor.

The memory may be configured to store processing programs, and the processor may load and execute the processing programs stored in the memory, to implement all or a part of the information processing methods provided by the present disclosure.

The readable storage medium may be configured to store computer programs.

When the computer programs are executed by a processor, all or a part of the information processing methods provided by the present disclosure may be implemented.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the another element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

It should also be noted that in this article, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the phrase “comprises a . . . ” or “includes a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: multiple units or components may be combined, or can be integrated into another system, or some features can be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to multiple network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units can be integrated into one unit. The above-mentioned integration units can be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that can store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a quantity of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. An information processing method, comprising:
determining at least two sessions corresponding to a first session object, wherein the at least two sessions have one-to-one correspondence with at least two second session objects;
analyzing the at least two sessions, to obtain session stages of the at least two sessions currently in corresponding session processes; and
determining that at least one session satisfies a preset condition based on the session stages of the at least two sessions currently in the corresponding session processes, and allocating at least one second session object to be connected to the first session object.

2. The method according to claim 1, wherein analyzing the at least two sessions to obtain the session stages of the at least two sessions currently in the corresponding session processes includes:
obtaining real-time session messages, wherein the real-time session messages are generated by the first session object or the at least two second session objects;
inputting the real-time session messages into a pre-trained first model, to obtain target vectors corresponding to the real-time session messages; and
inputting the target vectors into a pre-trained second model to obtain the target stages of the real-time session messages in the corresponding session processes.

3. The method according to claim 2, wherein inputting the real-time session messages into the pre-trained first model, to obtain the target vectors corresponding to the real-time session messages includes:
inputting the real-time session messages into a first module of the first model, such that the first module of the first model processes at least one word in the real-time session messages to obtain at least one first vector, wherein the at least one first vector corresponds to word in the real-time session messages; and
inputting the at least one first vector into a second module of the first model such that the second module of the first model processes the at least one first vector to obtain the target vectors corresponding to the real-time session messages.

4. The method according to claim 3, after the second module of the first model processes the at least one first vector to obtain the target vectors corresponding to the real-time session messages, further including:
determining whether the real-time session messages are related to a historical session message in the sessions; and
based on that the real-time session messages are related to the historical session message, adjusting the target vectors of the real-time session messages.

5. The method according to claim 2, wherein inputting the target vectors into the pre-trained second model to obtain the target stages of the real-time session messages in the corresponding session processes includes:
determining positions of the real-time session messages in corresponding sessions;
generating position vectors based on the positions in the corresponding sessions; and
inputting the position vectors and the target vectors into the second model, to obtain the target stages of the real-time session messages in the corresponding session processes.

6. The method according to claim 2, wherein inputting the target vectors into the pre-trained second model to obtain the target stages of the real-time session messages in the corresponding session processes includes:
inputting the target vectors into a first module of the second model, such that the first module of the second model identifies the context relationship of the target vectors and a historical target vector corresponding to a historical session message; and
inputting the context relationship into a second module of the second model, such that the second module of the second model identifies and obtains the target stages of the real-time session messages in the corresponding session processes based on the context relationship.

7. The method according to claim 2, further including training the first model and training the second model by performing:
adding a stage label to each session message in a training session record to obtain training session samples;
training a first original model based on the training session samples to obtain the first model;
inputting the training session samples into the first model to obtain training vectors; and
training a second original model based on the training vector to obtain the second model.

8. The method according to claim 2, wherein determining that the at least one session satisfies the preset condition includes:
based on the target stages being a first stage, determining a time length that one session is continuously in the first stage up to now; and
based on the time length being greater than a preset time length, determining that the session meets the preset condition.

9. The method according to claim 1, wherein, determining that the at least one session satisfies the preset condition based on the session stages of the at least two sessions currently in the corresponding session processes and allocating the at least one second session object to be connected to the first session object, includes:
determining that the at least one session satisfies the preset condition based on the session stages of the at least two sessions currently in the corresponding session processes, and, when a quantity of the at least one session, that satisfies the preset condition, satisfies a preset quantity condition, increasing an upper limit of a quantity of sessions corresponding to the first session object from a first value to a second value, wherein a quantity of the at least two second session objects equals to the first value;
allocating at least one new second session object to the first session object, wherein a sum of the quantity of the at least two second session objects and a quantity of the newly allocated at least one second session object equals to the second value; and
allocating the at least one second session object to be connected to the first session object.

10. An electronic device comprising:
at least one processor; and
at least one memory storing executable program instructions that, when being executed, cause the at least one processor to:
determine at least two sessions corresponding to a first session object, wherein the at least two sessions have one-to-one correspondence with at least two second session objects;
analyze the at least two sessions, to obtain session stages of the at least two sessions currently in corresponding session processes; and
determine that at least one session satisfies a preset condition based on the session stages of the at least two sessions currently in the corresponding session processes, and allocate at least one second session object to be connected to the first session object.

11. The electronic device according to claim 10, wherein the program instructions further cause the at least one processor to:
obtain real-time session messages, wherein the real-time session messages are generated by the first session object or the at least two second session objects;
input the real-time session messages into a pre-trained first model, to obtain target vectors corresponding to the real-time session messages; and
input the target vectors into a pre-trained second model to obtain the target stages of the real-time session messages in the corresponding session processes.

12. The electronic device according to claim 11, wherein the program instructions further cause the at least one processor to:
input the real-time session messages into a first module of the first model, such that the first module of the first model processes at least one word in the real-time session messages to obtain at least one first vector, wherein the at least one first vector corresponds to word in the real-time session messages; and
input the at least one first vector into a second module of the first model such that the second module of the first model processes the at least one first vector to obtain the target vectors corresponding to the real-time session messages.

13. The electronic device according to claim 12, wherein the program instructions further cause the at least one processor to:
determine whether the real-time session messages are related to a historical session message in the session; and
based on that the real-time session messages are related to the historical session message, adjust the target vectors of the real-time session messages.

14. The electronic device according to claim 11, wherein the program instructions further cause the at least one processor to:
determine positions of the real-time session messages in corresponding sessions;
generate position vectors based on the positions in the corresponding sessions; and
input the position vectors and the target vectors into the second model, to obtain the target stages of the real-time session messages in the corresponding session processes.

15. The electronic device according to claim 11, wherein the program instructions further cause the at least one processor to:
input the target vectors into a first module of the second model, such that the first module of the second model identifies the context relationship of the target vectors and a historical target vector corresponding to a historical session message; and
input the context relationship into a second module of the second model, such that the second module of the second model identifies and obtains the target stages of the real-time session messages in the corresponding session processes based on the context relationship.

16. The electronic device according to claim 11, wherein the program instructions further cause the at least one processor to train the first model and the second model by performing:
adding a stage label to each session message in a training session record to obtain training session samples;
training a first original model based on the training session samples to obtain the first model;
inputting the training session samples into the first model to obtain training vectors; and
training a second original model based on the training vector to obtain the second model.

17. The electronic device according to claim 11, wherein the program instructions further cause the at least one processor to:
based on the target stages being a first stage, determine a time length that one session is continuously in the first stage up to now; and
based on the time length being greater than a preset time length, determine that the session meets the preset condition.

18. The electronic device according to claim 10, wherein the program instructions further cause the at least one processor to:
determine that the at least one session satisfies the preset condition based on the session stages of the at least two sessions currently in the corresponding session processes, and, when a quantity of the at least one session, that satisfies the preset condition, satisfies a preset quantity condition, increase an upper limit of a quantity of sessions corresponding to the first session object from a first value to a second value, wherein a quantity of the at least two second session objects equals to the first value;
allocate at least one new second session object to the first session object, wherein a sum of the quantity of the at least two second session objects and a quantity of the newly allocated at least one second session object equals to the second value; and
allocate the at least one second session object to be connected to the first session object.

19. A non-transitory computer-readable storage medium storing executable program instructions that, when being executed, cause at least one processor to:
determine at least two sessions corresponding to a first session object, wherein the at least two sessions have one-to-one correspondence with at least two second session objects;
analyze the at least two sessions, to obtain session stages of the at least two sessions currently in corresponding session processes; and
determine that at least one session satisfies a preset condition based on the session stages of the at least two sessions currently in the corresponding session processes, and allocate at least one second session object to be connected to the first session object.

20. The storage medium according to claim 19, wherein the program instructions further cause the at least one processor to:
obtain real-time session messages, wherein the real-time session messages are generated by the first session object or the at least two second session objects;
input the real-time session messages into a pre-trained first model, to obtain target vectors corresponding to the real-time session messages; and
input the target vectors into a pre-trained second model to obtain the target stages of the real-time session messages in the corresponding session processes.
